(19) United States
(12) Patent Application Publication
(10) Pub. No.: US 2026/0200154 A1
(43) Pub. Date: Jul. 16, 2026

(54) REINFORCED PLASTIC EXTRUDED PART AND MANUFACTURING THEREOF

(71) Applicant: NAN YA PLASTICS CORPORATION, TAIPEI (TW)

(72) Inventors: CHING-YAO YUAN, TAIPEI (TW); CHUN-CHE TSAO, TAIPEI (TW); WEN-JUI CHENG, TAIPEI (TW)

(21) Appl. No.: 19/181,283

(22) Filed: Apr. 16, 2025

(30) Foreign Application Priority Data
Jan. 13, 2025 (TW) 114101223

(51) Int. Cl. B29C 48/00; B29C 48/09; B29K 101/12; B29K 105/00; B29K 105/14

(52) U.S. Cl. CPC B29C 48/022; B29C 48/09; B29K 2101/12; B29K 2105/0032; B29K 2105/0044; B29K 2105/14

(57) ABSTRACT

A reinforced plastic extruded part and a manufacturing method thereof are provided. The manufacturing method includes the steps of providing plastic pellets and forming the plastic pellets into a reinforced plastic extruded part by a single-screw extrusion operation. A raw material of the plastic pellets includes 1 wt % to 55 wt % of long fibers, based on a total weight of the raw material of the plastic pellets being 100 wt %. The long fibers have a length from 6 mm to 25 mm. The single-screw extrusion operation is performed under the conditions of a screw length-to-diameter ratio ranging from 26:1 to 30:1 and a screw compression ratio ranging from 3:1 to 4:1.

### CROSS-REFERENCE TO RELATED PATENT APPLICATION

This application claims the benefit of priority to Taiwan Patent Application No. 114101223, filed on Jan. 13, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a plastic extruded product, and more particularly to a reinforced plastic extruded part for bearing weight and a manufacturing method thereof.

### BACKGROUND OF THE DISCLOSURE

In the field of plastic molding and processing, industries demand for products not only have high performance and a lightweight property but also special structures or shapes. As a result, fiber-reinforced composites have gained significant attention. The basic composition of fiber-reinforced composites includes two main components, i.e., a thermoplastic resin and reinforcing fibers. These materials offer advantages such as rapid molding, high resin selectivity, easily processing, and high-temperature resistance.

For fiber-reinforced composites, the length of fibers is positively correlated with their mechanical performance. Sufficient fiber length allows the fibers to overlap each other, thereby enhancing mechanical properties of products. Therefore, compared to short fiber reinforced thermoplastic composites (SFT), long fiber reinforced thermoplastic composites (LFT) provide better reinforcement effects. However, during molding and processing, mechanical stress can cause the long fibers to break, so that only a small amount of the long fibers remains.

In addition, the dispersion uniformity of long fibers in a polymer material and the compatibility between the long fibers and the polymer material also significantly affect mechanical properties of a composite. Therefore, issues related to fiber distribution and the interface between fibers and resin must be addressed.

### SUMMARY OF THE DISCLOSURE

In response to the above-referenced technical inadequacies, the present disclosure provides a reinforced plastic extruded part and a manufacturing method thereof. One aspect of the present disclosure is to use a long fiber reinforced thermoplastic composite in a single-screw extrusion operation, so as to produce a reinforced plastic extruded part (such as a profile or tube) for bearing weight, which can be used in place of a metal part (such as an aluminum extruded part) in practical applications, and can bring the beneficial effects of reducing carbon dioxide emissions and reducing costs.

In order to solve the above-mentioned problems, one of the technical aspects adopted by the present disclosure is to provide a manufacturing method of a reinforced plastic extruded part, which includes the steps of providing plastic pellets and forming the plastic pellets into a reinforced plastic extruded part by a single-screw extrusion operation. In the present disclosure, a raw material of the plastic pellets includes 1 wt % to 55 wt % of long fibers, based on a total weight of the raw material of the plastic pellets being 100 wt %. The long fibers have a length from 6 mm to 25 mm. Furthermore, the single-screw extrusion operation is performed under the conditions of a screw length-to-diameter ratio ranging from 26:1 to 30:1 and a screw compression ratio ranging from 3:1 to 4:1.

In one of the possible or preferred embodiments, in the step of providing the plastic pellets, the long fibers are glass fibers or carbon fibers.

In one of the possible or preferred embodiments, an amount of the long fibers in the raw material of the plastic pellets ranges from 15 wt % to 40 wt %, and the length of the long fibers ranges from 6 mm to 15 mm.

In one of the possible or preferred embodiments, a fiber surface of each of the long fibers is coated with an interface layer by treating the long fibers with a sizing agent that includes a silane coupling agent, an acrylic resin, a polyurethane resin, or any combination thereof.

In one of the possible or preferred embodiments, the sizing agent includes a graft-modified polyurethane resin, and a graft monomer is an alkyl-containing (meth)acrylate, a hydroxyl-containing (meth)acrylate, or a carboxyl-containing monomer.

In one of the possible or preferred embodiments, the long fibers in one of the plastic pellets extend along a length direction of the one of the plastic pellets, and have a length equal to a length of the one of the plastic pellets.

In one of the possible or preferred embodiments, in the step of providing the plastic pellets, the raw material of the plastic pellets includes 45 wt % to 99 wt % of a thermoplastic resin.

In one of the possible or preferred embodiments, the thermoplastic resin is polypropylene, polyethylene terephthalate, or polyamide.

In one of the possible or preferred embodiments, the thermoplastic resin is polypropylene, and the raw material of the plastic pellets further includes 0 wt % to 15 wt % of an ethylene-containing copolymer grafted with a polar functional group-containing monomer.

In one of the possible or preferred embodiments, the polar functional group-containing monomer is maleic anhydride, and the ethylene-containing copolymer is ethylene-propylene copolymer.

In one of the possible or preferred embodiments, the raw material of the plastic pellets further includes at least one additive that is at least one of a slip agent, an ultraviolet absorber, a light stabilizer, and a colorant.

In order to solve the above-mentioned problems, another one of the technical aspects adopted by the present disclosure is to provide a reinforced plastic extruded part, which is obtained by the manufacturing method as described above. The reinforced plastic extruded part includes the long fibers having a length of greater than 5 mm.

In one of the possible or preferred embodiments, the reinforced plastic extruded part has a surface roughness Ra of less than 0.3 μm.

In one of the possible or preferred embodiments, the reinforced plastic extruded part is a tube having a length from 2 m to 3 m and a wall thickness from 1.2 mm to 4 mm, and a sag deformation of the tube measured at 40° C., with a load of 2 kg, and after 2 days is less than 7 mm.

In conclusion, the manufacturing method of a reinforced plastic extruded part provided by the present disclosure, by virtue of forming the plastic pellets into a reinforced plastic extruded part by a single-screw extrusion operation and the single-screw extrusion operation being performed under the conditions of a screw length-to-diameter ratio ranging from 26:1 to 30:1 and a screw compression ratio ranging from 3:1 to 4:1, can make products that have good mechanical properties. Specifically, a resulting extruded part still includes long fibers having a length of greater than 5 mm that overlap each other to form a three-dimensional network structure, thus providing a reinforcing skeleton. Therefore, the resulting extruded part can meet the requirements of high strength and high rigidity and have a lightweight property.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a manufacturing method of a reinforced plastic extruded part of the present disclosure;

FIG. 2 is a perspective schematic view of plastic pellets used for the manufacturing method of the reinforced plastic extruded part of the present disclosure;

FIG. 3 is a perspective view of the plastic pellets used for the manufacturing method of the reinforced plastic extruded part of the present disclosure;

FIG. 4 is a front schematic view of the plastic pellets used for the manufacturing method of the reinforced plastic extruded part of the present disclosure; and

FIG. 5 is a schematic view of a screw used for the manufacturing method of the reinforced plastic extruded part of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### [Manufacturing Method of Reinforced Plastic Extruded Part]

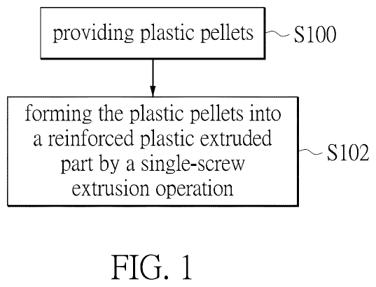

Referring to FIG. 1, the present disclosure provides a manufacturing method of a reinforced plastic extruded part, which includes: step S100, providing plastic pellets; and step S102, forming the plastic pellets into a reinforced plastic extruded part by a single-screw extrusion operation. In the present disclosure, the plastic pellets are LFRT (Long Fiber Reinforced Thermoplastic) pellets and thus advantageous for increasing strength and rigidity of products without increasing the thickness of the products. The single-screw extrusion operation can effectively reduce instances of fiber breakage, thus ensuring product quality. Therefore, a reinforced plastic extruded part obtained by the manufacturing method of the present disclosure can be used in place of a metal part (such as an aluminum extruded part) in practical applications. More details about each step of the manufacturing method will be described below.

In step S100, a raw material of the plastic pellets mainly includes 45 wt % to 99 wt % of a thermoplastic resin and 1 wt % to 55 wt % of long fibers, based on a total weight of the raw material of the plastic pellets being 100 wt %. In consideration for improvement of mechanical properties, the thermoplastic resin can be a polypropylene resin, polyethylene terephthalate, or a polyamide resin. The long fibers can be glass fibers or carbon fibers, and have a length from 6 mm to 25 mm. It should be noted that a higher fiber content and a longer fiber length in the plastic pellets can make the product have good mechanical properties.

In one of the preferred embodiments, an amount of the long fibers in the raw material of the plastic pellets ranges from 15 wt % to 40 wt %, and the length of the long fibers ranges from 6 mm to 15 mm. It is worth mentioning that if the amount of the long fibers in the raw material of the plastic pellets is too low, a resulting product would fail to meet required strength. If the amount of the long fibers in the raw material of the plastic pellets is too high, the extrusion molding of the thermoplastic resin would be negatively affected, and a product surface would become rough to affect the tactile sense.

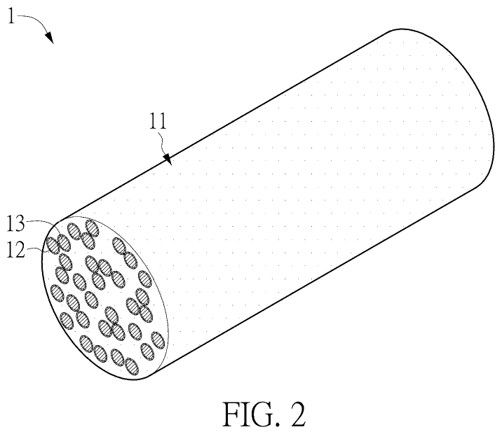

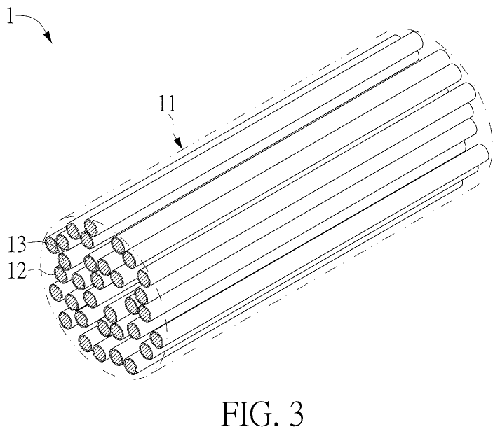

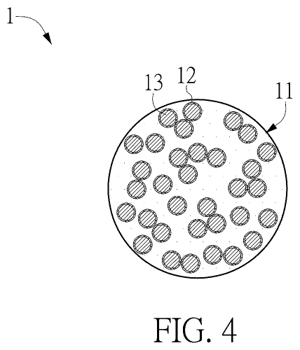

Reference is made to FIG. 2 to FIG. 4. The plastic pellets 1 can be formed from a unidirectional thermoplastic pellet, and each can include a cured resin matrix 11 and a number of long fibers 12 wrapped in the resin matrix 11, in which the resin matrix 11 includes a thermoplastic resin. The long fibers 12 in one of the plastic pellets 1 extend along a length direction of the one of the plastic pellets 1, and have a length equal to a length of the one of the plastic pellets 1. In order to improve the adhesion of the long fibers 12 to the resin matrix 11, the long fibers 12 can be treated with a sizing agent, such that a fiber surface of each of the long fibers 12 is coated with an interface layer 13. The sizing agent can include a silane coupling agent, an acrylic resin, a polyurethane resin, or any combination thereof, but is not limited thereto.

It is worth mentioning that the plastic pellets 1 having a length that is too long (a length of greater than 25 mm) may cause difficult feeding, while the plastic pellets 1 having a length that is too short (a length of less than 6 mm) provide no long fiber reinforcement effect, resulting in insufficient strength of a resulting product. Therefore, the present disclosure, by controlling the length of the long fibers 12 to be the same as the length of the plastic pellets 1 (a length of 6-25 mm), can improve uniform stability of a fiber/resin system, so that the long fibers 12 are well dispersed during a molding process, which is advantageous for achieving good mechanical properties.

The polyurethane resin as the sizing agent can be a graft-modified polyurethane resin, in which a graft monomer can be an alkyl-containing (meth)acrylate, a hydroxyl-containing (meth)acrylate, or a carboxyl-containing monomer.

Specific examples of the alkyl-containing (meth)acrylate include methyl (meth)acrylate, ethyl (meth)acrylate, propyl (meth)acrylate, n-butyl (meth)acrylate, isobutyl (meth)acrylate, 2-ethylhexyl (meth)acrylate, n-octyl (meth)acrylate, isooctyl (meth)acrylate, lauryl (meth)acrylate, octadecyl (meth)acrylate, cyclohexyl (meth)acrylate, methoxyethyl (meth)acrylate, and ethoxymethyl (meth)acrylate.

Specific examples of the hydroxyl-containing (meth)acrylate include 2-hydroxyethyl (meth)acrylate, 4-hydroxybutyl (meth)acrylate, 3-chloro-2-hydroxypropyl methacrylate, and diethylene glycol (meth)acrylate.

Specific examples of the carboxyl-containing monomer include acrylic acid, methacrylic acid, itaconic acid, crotonic acid, maleic acid, and fumaric acid.

In practice, the sizing agent can be dispersed in water to form a stable treatment solution. Afterwards, the long fibers 12 are immersed in the treatment solution to make the sizing agent adhere to surfaces of the long fibers 12, and are then dried to remove water. If necessary, a heat curing agent or light curing agent can be added to the treatment solution to be used in combination with the sizing agent. However, the above description is for exemplary purposes only, and is not meant to limit the scope of the present disclosure.

When the thermoplastic resin is a non-polar resin (such as a polypropylene resin), the raw material of the plastic pellets can further include an ethylene-containing copolymer grafted with a polar functional group-containing monomer, so as to improve the bonding strength between the resin matrix 11 and the long fibers 12. Such a copolymer can improve the wettability of the resin matrix 11 on the long fibers 12, thereby improving the compatibility between the resin matrix 11 and the long fibers 12.

More specifically, an amount of the ethylene-containing copolymer grafted with the polar functional group-containing monomer in the raw material of the plastic pellets can be from 1 wt % to 15 wt %. Examples of the polar functional group-containing monomer include maleic acid, maleic anhydride, itaconic acid, itaconic anhydride, acrylic acid, methacrylic acid, acrylate, methacrylate, and silanes. Examples of the ethylene-containing copolymer include copolymers of ethylene and C3 to C10 α-olefins.

In one of the preferred embodiments, the polar functional group-containing monomer is maleic anhydride, and the ethylene-containing copolymer is ethylene-propylene copolymer with an ethylene content of 12 wt %. A grafting rate of maleic anhydride on the molecular chain of the ethylene-propylene copolymer is 0.5% to 5%.

The polypropylene resin suitable for use in the plastic pellets of the present disclosure can have a melt flow index (MI) from 5 g/10 min to 75 g/10 min measured according to the ISO 1133 standard and a density of 0.9 g/cm³ measured according to the ISO 1183 standard. The ethylene-propylene copolymer suitable for use in the plastic pellets of the present disclosure can have a melt flow index from 10 g/10 min to 30 g/10 min measured according to the ISO 1133 standard.

If necessary, the raw material of the plastic pellets can further include 0 wt % to 6 wt % of at least one additive. For example, the at least one additive can be at least one of a slip agent, an ultraviolet absorber, a light stabilizer, and a colorant, so as to meet manufacturing or use requirements. An amount of the slip agent can be from 0 wt % to 5 wt %. An amount of the ultraviolet absorber can be from 0 wt % to 1 wt %. An amount of the light stabilizer can be from 0 wt % to 1 wt %. An amount of the colorant can be from 0 wt % to 4 wt %. However, such examples are not intended to limit the scope of the present disclosure.

In step S102, the plastic pellets are heated and plasticized into a melt by a screw. Afterwards, the melt is pushed to an extrusion die by the screw, so as to continuously produce extruded parts with a specific structure and shape along an extrusion direction, and finished products can be obtained after cooling, shaping, and cutting, such as, but not limited to, tubes and profiles.

More specifically, in the single-screw extrusion operation, a heating temperature range of the screw can be divided into four ranges, including a first range from 160° C. to 240° C., a second range from 190° C. to 280° C., a third range from 210° C. to 290° C., and a fourth range from 210° C. to 290° C. A heating temperature of a die head ranges from 150° C. to 290° C. A rotation speed of the screw can be controlled within the range from 5 rpm to 50 rpm. A pulling speed can be controlled within the range from 0.3 m/min to 2.0 m/min. However, the above description is for exemplary purposes only, and is not meant to limit the scope of the present disclosure.

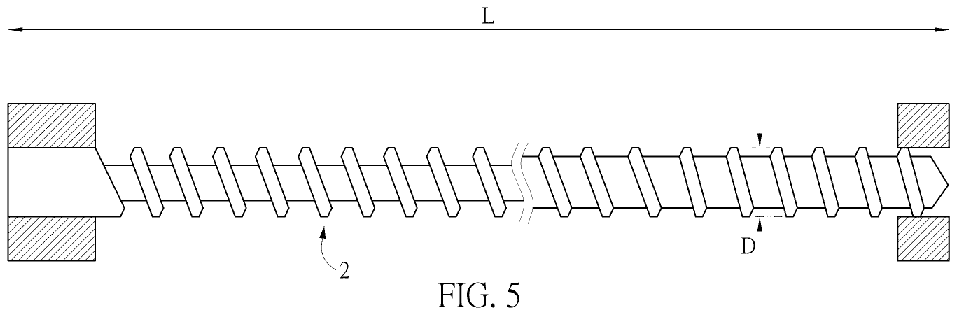

Reference is made to FIG. 5. In order to reduce instances of fiber breakage in the single-screw extrusion operation, the screw 2 used for the single-screw extrusion operation at least has the following structural features: a ratio of a working length L of the screw 2 to an outer diameter D of the screw 2 (length-to-diameter ratio L/D) ranges from 26:1 to 30:1; and a compression ratio of the screw 2 ranges from 3:1 to 4:1. Therefore, the strength and rigidity of extruded parts are significantly improved.

It should be noted that if the compression ratio of the screw 2 is too low, it is easy to cause poor product quality. If the compression ratio of the screw 2 is too high, it is easy to cause fiber breakage and damage the strength of a resulting product. Furthermore, if the length-to-diameter ratio L/D of the screw 2 is too high, it is easy to cause fiber breakage and damage the strength of a resulting product.

### [Reinforced Plastic Extruded Part]

The present disclosure further provides a reinforced plastic extruded part, which is obtained by the manufacturing method as described above. It is worth mentioning that long fibers present in the reinforced plastic extruded part still have a length of greater than 5 mm and overlap each other to form a three-dimensional network structure, which can serve as a reinforcing skeleton, by using the plastic pellets provided by step S100 in the single-screw extrusion operation adopted by step S102. Therefore, the reinforced plastic extruded part of the present disclosure can meet the requirements of high strength and high rigidity and have a lightweight property, and can be used in place of a metal part (such as an aluminum extruded part) in practical applications.

It should be noted that the reinforced plastic extruded part of the present disclosure has good load-bearing strength. A profile extrusion tube having a length from 2 m to 3 m and a wall thickness from 1.2 mm to 4 mm is taken as an example, and a sag deformation of the profile extrusion tube measured at 40° C., with a load of 2 kg, and after 2 days is less than 7 mm.

In one of the possible embodiments, the reinforced plastic extruded part of the present disclosure has a surface roughness Ra of less than 0.3 μm.

### Examples and Comparative Examples

In the plastic pellets of Example 1, the resin matrix is a polypropylene resin, and the content ratio of the resin matrix to the long fibers is 7:3. The plastic pellets of Example 1 are made into a tube sample by using step S102, in which the temperature of the extrusion die head is 200° C.

The difference between Example 2 and Example 1 is as follows: in Example 2, the resin matrix is a polyethylene terephthalate, and in the single-screw extrusion operation, the temperature of the extrusion die head is 260° C.

The difference between Example 3 and Example 1 is as follows: in Example 3, the resin matrix is nylon 6 (polyamide resin), and in the single-screw extrusion operation, the temperature of the extrusion die head is 260° C.

The difference between Example 4 and Example 1 is as follows: in Example 4, the resin matrix is nylon 66 (polyamide resin), and in the single-screw extrusion operation, the temperature of the extrusion die head is 285° C.

The difference between Comparative Examples 1-3 and Example 1 is as follows: the plastic pellets of Comparative Examples 1-3 do not contain long glass fibers; in the plastic pellets of Comparative Example 2, the resin matrix is polyethylene terephthalate; in the plastic pellets of Comparative Example 3, the resin matrix is nylon 6 (polyamide resin); and the extrusion condition of Comparative Examples 1-3 is different from that of Example 1, i.e., the temperature of the extrusion die head is 260° C.

Tube samples of Examples 1~4 and Comparative Examples 1-3 are tested for load-bearing strength. The test method is described below, and the test results are listed in Table 1 and Table 2 below.

Load-bearing strength: placing a tube sample having a length of 2 m and a wall thickness of 3 mm in a 40° C. oven and fixing both sides of the tube sample (a fixed length of one side is 10 cm), then applying a 2 kg load to the middle position of the tube sample, after 2 days, taking out the tube sample and measuring a sag deformation of the tube sample (a sag deformation of less than 7 mm is qualified).

TABLE 1

| Items | | Example 1 | Example 2 | Example 3 | Example 4 |
|---|---|---|---|---|---|
| Raw | Resin matrix | PP | PET | PA6 | PA66 |
| material of | Resin content (wt %) | 70 | 70 | 70 | 70 |
| plastic pellet | 11 mm long fiber | 30 | 30 | 30 | 30 |
| | content (wt %) | | | | |
| Single-screw | Die head | 220 | 260 | 260 | 285 |
| extrusion | Temperature (° C.) | | | | |
| operation | Profile extrusion | Molded | Molded | Molded | Molded |
| | moldability | successfully | successfully | successfully | successfully |
| Heat load | Sag deformation (mm) | 4.85 | 6.1 | 3.05 | 2.12 |
| test | Evaluated result | Qualified | Qualified | Qualified | Qualified |

TABLE 2

| | | Comparative | Comparative | Comparative |
|---|---|---|---|---|
| Items | | Example 1 | Example 2 | Example 3 |
| Raw | Resin matrix | PP | PET | PA6 |
| material of | Resin content (wt %) | 100 | 100 | 100 |
| plastic pellet | 11 mm long fiber | 0 | 0 | 0 |
| | content (wt %) | | | |
| Single-screw | Die head | 220 | 260 | 260 |
| extrusion | Temperature (° C.) | | | |
| operation | Profile extrusion | Molded | Molded | Molded |
| | moldability | successfully | unsuccessfully | successfully |
| Heat load | Sag deformation (mm) | 11.2 | 6.1 | 8.92 |
| test | Evaluated result | NG | Qualified | NG |

It can be seen from Table 1 and Table 2 that a reinforced plastic extruded part having excellent load-bearing strength can be obtained by using a long fiber reinforced thermoplastic composite based on PP, PET, or PA in a single-screw extrusion operation performed under the conditions of a screw length-to-diameter ratio ranging from 26:1 to 30:1 and a screw compression ratio ranging from 3:1 to 4:1.

### Beneficial Effects of the Embodiments

The manufacturing method of a reinforced plastic extruded part provided by the present disclosure, by virtue of forming the plastic pellets into a reinforced plastic extruded part by a single-screw extrusion operation and the single-screw extrusion operation being performed under the conditions of a screw length-to-diameter ratio ranging from 26:1 to 30:1 and a screw compression ratio ranging from 3:1 to 4:1, can make products have good mechanical properties. Specifically, a resulting extruded part still includes long fibers having a length of greater than 5 mm that overlap each other to form a three-dimensional network structure, thus providing a reinforcing skeleton. Therefore, the resulting extruded part can meet the requirements of high strength and high rigidity and have a lightweight property.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A manufacturing method of a reinforced plastic extruded part, comprising:
providing plastic pellets, wherein a raw material of the plastic pellets includes 1 wt % to 55 wt % of long fibers, based on a total weight of the raw material of the plastic pellets being 100 wt %, and the long fibers having a length from 6 mm to 25 mm; and
forming the plastic pellets into a reinforced plastic extruded part by a single-screw extrusion operation, wherein the single-screw extrusion operation is performed under the conditions of a screw length-to-diameter ratio ranging from 26:1 to 30:1 and a screw compression ratio ranging from 3:1 to 4:1.

2. The manufacturing method according to claim 1, wherein, in the step of providing the plastic pellets, the long fibers are glass fibers or carbon fibers.

3. The manufacturing method according to claim 2, wherein an amount of the long fibers in the raw material of the plastic pellets ranges from 15 wt % to 40 wt %, and the length of the long fibers ranges from 6 mm to 15 mm.

4. The manufacturing method according to claim 2, wherein a fiber surface of each of the long fibers is coated with an interface layer by treating the long fibers with a sizing agent that includes a silane coupling agent, an acrylic resin, a polyurethane resin, or any combination thereof.

5. The manufacturing method according to claim 4, wherein the long fibers in one of the plastic pellets extend along a length direction of the one of the plastic pellets, and have a length equal to a length of the one of the plastic pellets.

6. The manufacturing method according to claim 1, wherein, in the step of providing the plastic pellets, the raw material of the plastic pellets includes 45 wt % to 99 wt % of a thermoplastic resin.

7. The manufacturing method according to claim 6, wherein the thermoplastic resin is polypropylene, polyethylene terephthalate, or polyamide.

8. The manufacturing method according to claim 7, wherein the thermoplastic resin is polypropylene, and the raw material of the plastic pellets further includes 0 wt % to 15 wt % of an ethylene-containing copolymer grafted with a polar functional group-containing monomer.

9. The manufacturing method according to claim 8, wherein the polar functional group-containing monomer is maleic anhydride, and the ethylene-containing copolymer is ethylene-propylene copolymer.

10. The manufacturing method according to claim 6, wherein the raw material of the plastic pellets further includes at least one additive that is at least one of a slip agent, an ultraviolet absorber, a light stabilizer, and a colorant.

11. A reinforced plastic extruded part obtained by the manufacturing method as claimed in claim 1, wherein the reinforced plastic extruded part includes the long fibers having a length of greater than 5 mm.

12. The reinforced plastic extruded part according to claim 11, wherein the reinforced plastic extruded part has a surface roughness Ra of less than 0.3 μm.

13. The reinforced plastic extruded part according to claim 11, wherein the reinforced plastic extruded part is a tube having a length from 2 m to 3 m and a wall thickness from 1.2 mm to 4 mm, and a sag deformation of the tube measured at 40° C., with a load of 2 kg, and after 2 days is less than 7 mm.
